(19) United States
(12) Patent Application Publication
(10) Pub. No.: US 2018/0356093 A1
(43) Pub. Date: Dec. 13, 2018

(54) METHODS OF OPERATING A ROTATING DETONATION COMBUSTOR AT APPROXIMATELY CONSTANT DETONATION CELL SIZE

(71) Applicant: General Electric Company, Schenectady, NY (US)

(72) Inventors: Sibtosh Pal, Mason, OH (US); Joseph Zelina, Waynesville, OH (US); Arthur Wesley Johnson, Cincinnati, OH (US); Clayton Stuart Cooper, Loveland, OH (US); Steven Clayton Vise, Loveland, OH (US)

(21) Appl. No.: 15/618,380

(22) Filed: Jun. 9, 2017

(51) Int. Cl. F23R 3/04; F02C 5/12

(52) U.S. Cl. CPC F23R 3/04; F05D 2220/32; F05D 2240/35; F02C 5/12

(57) ABSTRACT

The present disclosure is directed to a method of operating a propulsion system including a rotating detonation combustion (RDC) system. The RDC system defines a combustion inlet at an upstream end, a combustion outlet at a downstream end, a combustion chamber therebetween, and a nozzle defined at the combustion inlet upstream of the combustion chamber, and a secondary flowpath extended from upstream of the nozzle to downstream of the nozzle. The method includes providing the combustion chamber of the rotating detonation combustion system to produce a detonation cell size configured for a first operating condition defining a lowest steady state operating condition of the propulsion system; generating a flow of oxidizer to the combustion inlet of the combustion section; providing a first portion of the flow of oxidizer to the combustion chamber and mixing the first portion of the flow of oxidizer with a fuel; providing a second portion of the flow of oxidizer to the secondary flowpath, wherein the secondary flowpath bypasses the combustion chamber; and adjusting a ratio of the first portion of the flow of oxidizer through the combustion chamber versus the second portion of the flow of oxidizer through the secondary flowpath based at least on a commanded power output of the propulsion system.

### FIELD

The present subject matter relates generally to a system of continuous detonation in a propulsion system.

### BACKGROUND

Many propulsion systems, such as gas turbine engines, are based on the Brayton Cycle, where air is compressed adiabatically, heat is added at constant pressure, the resulting hot gas is expanded in a turbine, and heat is rejected at constant pressure. The energy above that required to drive the compression system is then available for propulsion or other work. Such propulsion systems generally rely upon deflagrative combustion to burn a fuel/air mixture and produce combustion gas products which travel at relatively slow rates and constant pressure within a combustion chamber. While engines based on the Brayton Cycle have reached a high level of thermodynamic efficiency by steady improvements in component efficiencies and increases in pressure ratio and peak temperature, further improvements are welcomed nonetheless.

Accordingly, improvements in engine efficiency have been sought by modifying the engine architecture such that the combustion occurs as a detonation in either a continuous or pulsed mode. The pulsed mode design involves one or more detonation tubes, whereas the continuous mode is based on a geometry, typically an annulus, within which single or multiple detonation waves spin. For both types of modes, high energy ignition detonates a fuel/air mixture that transitions into a detonation wave (i.e., a fast moving shock wave closely coupled to the reaction zone). The detonation wave travels in a Mach number range greater than the speed of sound (e.g., Mach 4 to 8) with respect to the speed of sound of the reactants. The products of combustion follow the detonation wave at the speed of sound relative to the detonation wave and at significantly elevated pressure. Such combustion products may then exit through a nozzle to produce thrust or rotate a turbine. With various rotating detonation systems, the task of preventing backflow into the lower pressure regions upstream of the rotating detonation has been addressed by providing a steep pressure drop into the combustion chamber. However, such may reduce the efficiency benefits of the rotating detonation combustion system.

Generally, a detonation combustion system is based on whether a minimum quantity of detonation cells can be sustained in an annular combustion chamber. The detonation cell is characterized by a cell width (λ) that depends on the type of fuel and oxidizer as well as the pressure and temperature of the reactants at the combustion chamber and the stoichiometry (φ) of the reactants. For each combination of fuel and oxidizer, cell size decreases with increasing pressure and temperature, and for stoichiometry greater than or less than 1.0. In various propulsion system apparatuses, such as for gas turbine engines, the cell width may decrease by 20 times or more from a lowest steady state operating condition (e.g., ground idle) to a highest steady state operating condition (e.g., maximum takeoff).

It is generally known in the art that combustion chamber geometry is defined by a desired detonation cell size based on the fuel-oxidizer mixture and the pressure, temperature, and stoichiometric ratio thereof. Various combinations of fuel-oxidizer mixture, pressure, temperature, and stoichiometric ratio (e.g., at various operating conditions of the propulsion system) may render a fixed geometry combustion chamber inefficient at more than one operating condition. However, variable geometry combustion chambers generally involve complex structures that may significantly reduce or eliminate overall propulsion system efficiency or operability.

Therefore, there is a need for a detonation combustion system that provides low pressure drop operation and adjusts detonation cell size while mitigating the complexities of known detonation combustion systems.

### BRIEF DESCRIPTION

Aspects and advantages of the invention will be set forth in part in the following description, or may be obvious from the description, or may be learned through practice of the invention.

The present disclosure is directed to a method of operating a propulsion system including a rotating detonation combustion (RDC) system. The RDC system defines a combustion inlet at an upstream end, a combustion outlet at a downstream end, a combustion chamber therebetween, and a nozzle defined at the combustion inlet upstream of the combustion chamber, and a secondary flowpath extended from upstream of the nozzle to downstream of the nozzle. The method includes providing the combustion chamber of the rotating detonation combustion system to produce a detonation cell size configured for a first operating condition defining a lowest steady state operating condition of the propulsion system; generating a flow of oxidizer to the combustion inlet of the combustion section; providing a first portion of the flow of oxidizer to the combustion chamber and mixing the first portion of the flow of oxidizer with a fuel; providing a second portion of the flow of oxidizer to the secondary flowpath, wherein the secondary flowpath bypasses the combustion chamber; and adjusting a ratio of the first portion of the flow of oxidizer through the combustion chamber versus the second portion of the flow of oxidizer through the secondary flowpath based at least on a commanded power output of the propulsion system.

In various embodiments, adjusting the ratio of the first portion versus the second portion of the flow of oxidizer includes actuating an actuating structure at the primary flowpath and the secondary flowpath upstream of the combustion chamber and at or downstream of the combustion inlet of the combustion section. In one embodiment, actuating the actuating structure includes one or more of actuating a vane, valve, door, or wall varying the ratio of the flow of the first portion versus the second portion of the flow of oxidizer.

In another embodiment, adjusting a ratio of the first portion and second portion of oxidizer is based at least on maintaining an approximately constant detonation cell size at a stoichiometric ratio of detonated fuel and first portion of oxidizer of approximately 1.0 or less at a second operating condition greater than the first operating condition of the propulsion system.

In yet various embodiments, the method further includes providing the second portion of flow of oxidizer from the secondary flowpath to the primary flowpath. In one embodiment, providing the second portion of flow of oxidizer to the primary flowpath includes providing the second portion to combustion products downstream of a detonation wave of the mixture of the first portion of oxidizer and fuel. In another embodiment, providing the second portion of flow of oxidizer includes providing the second portion of oxidizer to one or more of a turbine section, an exhaust section, and atmospheric condition.

In still another embodiment, providing the second portion of the flow of oxidizer to the secondary flowpath includes flowing the second portion of oxidizer proximate to the combustion chamber to induce thermal attenuation of the combustion chamber.

In one embodiment, adjusting the ratio of the first portion and second portion of the flow of oxidizer based at least on a commanded power output further includes adjusting one or more of a flow of oxidizer to the rotating detonation combustion system and a flow of fuel to the combustion chamber.

In another embodiment, the method further includes providing a flow of fuel and mixing with the first portion of the oxidizer at the combustion chamber; and adjusting the flow of fuel based at least on the commanded power output of the propulsion system.

In yet another embodiment, the method further includes providing a third portion of oxidizer to the combustion chamber based at least on the second portion of oxidizer; providing a fourth portion of oxidizer to the exhaust section based at least on a portion of the second portion of oxidizer; and adjusting a ratio of the third portion of oxidizer to the combustion chamber versus the fourth portion of oxidizer to the exhaust section.

In one embodiment, adjusting the ratio of the third portion of oxidizer versus the fourth portion of oxidizer is based at least on the commanded power output of the propulsion system. In another embodiment, adjusting a ratio of the third portion of oxidizer to the combustion chamber is further based at least on maintaining an approximately equal detonation cell size from the first operating condition to a second operating condition greater than the first operating condition of the propulsion system.

In yet another embodiment, providing the combustion chamber of the rotating detonation combustion system includes providing a fixed volume combustion chamber defined by a combustion chamber length and a combustion chamber width.

In still another embodiment, the method further includes generating combustion products within the combustion chamber by detonating the mixture of fuel and the first portion of oxidizer.

The present disclosure is further directed to a propulsion system. The propulsion system includes an inlet section at the upstream end into which an oxidizer flows; an exhaust section at the downstream end; and a rotating detonation combustion (RDC) system disposed between the inlet section and the exhaust section through which a primary flowpath of the oxidizer is defined through the inlet section, the exhaust section, and the RDC system, wherein the RDC system includes a generally cylindrical walled enclosure defining a combustion chamber, a combustion inlet, and a combustion outlet, and further including a nozzle assembly at the combustion inlet, wherein the nozzle assembly defines a nozzle inlet proximate to the inlet section, a nozzle outlet proximate to the combustion chamber, and a throat and fuel injection port each disposed therebetween, and wherein the nozzle assembly defines a converging-diverging nozzle; and an actuation structure disposed upstream of the nozzle assembly of the RDC system, wherein a secondary flowpath is defined from the actuation structure to the combustion chamber or downstream thereof and bypassing the nozzle assembly, and wherein the actuation structure is configured to adjust a ratio from an overall flow of oxidizer of a first portion of oxidizer through the primary flowpath through the nozzle assembly and the combustion chamber and a second portion of oxidizer to through the secondary flowpath bypassing the nozzle assembly.

In one embodiment of the propulsion system the actuation structure defines a plurality of articulating vanes, valves, walls, doors, or combinations thereof

In another embodiment of the propulsion system, the actuation structure is disposed in the inlet section of the propulsion system.

In yet another embodiment, the propulsion system, further includes a second actuation structure disposed within the secondary flowpath, wherein the secondary flowpath extends to and in fluid communication with the combustion chamber, and wherein a tertiary flowpath is defined from the second actuation structure to the exhaust section. In one embodiment, the second actuation structure is configured to adjust a ratio from the second portion of oxidizer of a third portion of oxidizer to the combustion chamber and a fourth portion of oxidizer to the exhaust section.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic view of a propulsion system in accordance with an exemplary embodiment of the present disclosure;

FIG. 2 is a cross-sectional view of a rotating detonation combustion system in accordance with an exemplary embodiment of the present disclosure;

FIG. 3 is a cross-sectional view of a rotating detonation combustion system in accordance with another exemplary embodiment of the present disclosure;

FIG. 4 is another schematic view of a propulsion system in accordance with an exemplary embodiment of the present disclosure;

FIG. 5 is an exemplary embodiment of a combustion chamber of a rotating detonation combustion system in accordance with an embodiment of the present disclosure;

FIG. 6 is a cross-sectional view of a forward end of a rotating detonation combustion system in accordance with an exemplary embodiment of the present disclosure;

FIG. 7 is a cross-sectional view of a forward end of a rotating detonation combustion system in accordance with another exemplary embodiment of the present disclosure;

FIG. 8 is a flowchart including steps of an exemplary embodiment of a method of operating a propulsion system at an approximately constant detonation cell size in the combustion chamber of a detonation combustion system; and

FIG. 9 is another flowchart including steps of an exemplary embodiment of a method of operating a propulsion system at an approximately constant detonation cell size in the combustion chamber of a detonation combustion system.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components.

The terms “forward” and “aft” refer to relative positions within a propulsion system or vehicle, and refer to the normal operational attitude of the propulsion system or vehicle. For example, with regard to a propulsion system, forward refers to a position closer to a propulsion system inlet and aft refers to a position closer to a propulsion system nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

A propulsion system including a rotating detonation combustion (RDC) system, and method of operation thereof, is generally provided that may produce an approximately constant detonation cell size across a plurality of operating conditions of the RDC system and propulsion system. The methods and structures generally provided may produce an approximately constant detonation cell size of a fuel-oxidizer detonation within the combustion chamber of the RDC system in a fixed or constant volume across a plurality of operating conditions of the propulsion system. The methods and structures generally provided herein may reduce or mitigate complexities, and potential failures thereof, of systems including variable combustion chamber volumes or geometries. Furthermore, the methods and structures generally provided herein may enable efficient stable operation of the RDC system across a plurality of operating conditions while producing a fuel-oxidizer detonation stoichiometry of approximately 1.0 or less while enabling approximately constant detonation cell sizes relative to a lowest steady state operating condition of the propulsion system.

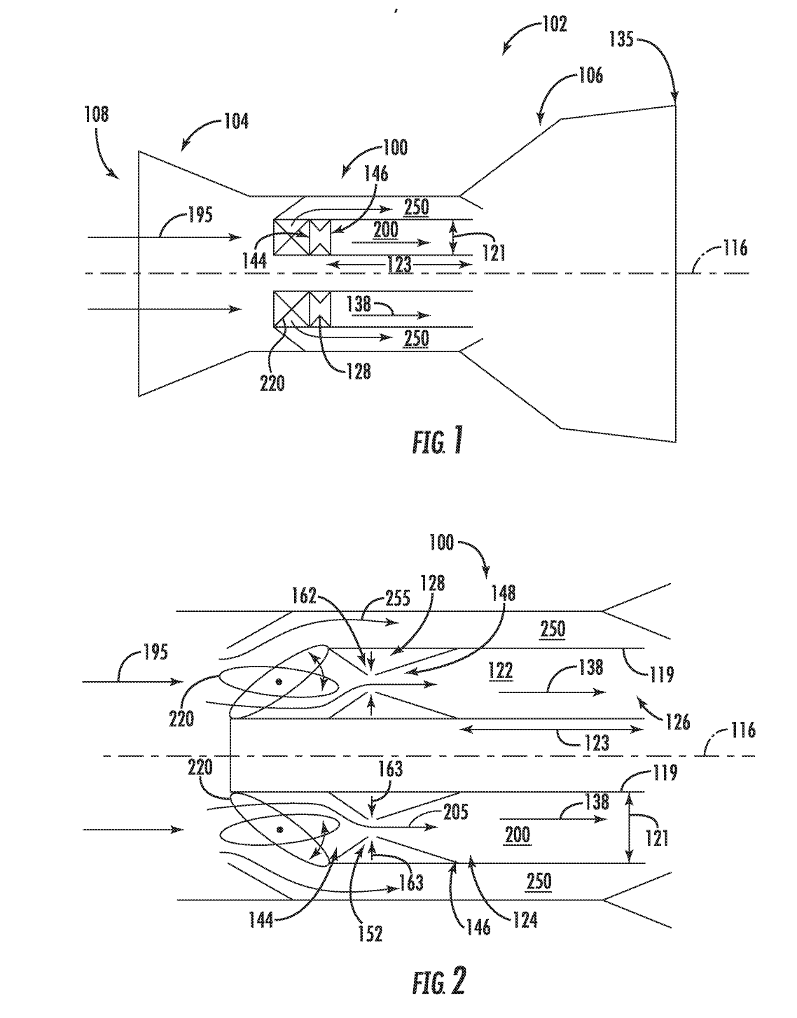

Referring now to the figures, FIG. 1 depicts a propulsion system 102 including a rotating detonation combustion system 100 (an “RDC system”) in accordance with an exemplary embodiment of the present disclosure. The propulsion system 102 generally includes an inlet section 104 and an outlet section 106, with the RDC system 100 located downstream of the inlet section 104 and upstream of the exhaust section 106. In various embodiments, the propulsion system 102 defines a gas turbine engine, a ramjet, or other propulsion system including a fuel-oxidizer burner producing combustion products that provide propulsive thrust or mechanical energy output. In an embodiment of the propulsion system 102 defining a gas turbine engine, the inlet section 104 includes a compressor section defining one or more compressors admitting an overall flow of oxidizer 195 through an inlet 108 to the RDC system 100. The inlet section 104 may generally guide a flow of the oxidizer 195 to the RDC system 100. The inlet section 104 may further compress the oxidizer 195 before it enters the RDC system 100. The inlet section 104 defining a compressor section may include one or more alternating stages of rotating compressor airfoils. In other embodiments, the inlet section 104 may generally define a decreasing cross sectional area from an upstream end to a downstream end proximate to the RDC system 100.

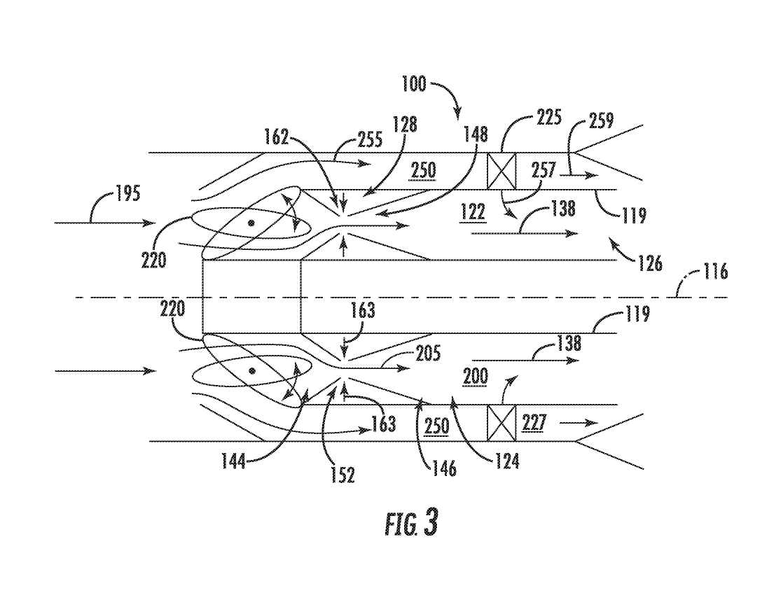

As will be discussed in further detail below, at least a portion of the overall flow of oxidizer 195 is mixed with a fuel 163 (shown in FIG. 2) to generate combustion products 138. The combustion products 138 flow downstream to the exhaust section 106. In various embodiments, the exhaust section 106 may generally define an increasing cross sectional area from an upstream end proximate to the RDC system 100 to a downstream end of the propulsion system 102. Expansion of the combustion products 138 generally provides thrust that propels the apparatus to which the propulsion system 102 is attached, or provides mechanical energy to one or more turbines further coupled to a fan section, a generator, or both. Thus, the exhaust section 106 may further define a turbine section of a gas turbine engine including one or more alternating rows or stages of rotating turbine airfoils. The combustion products 138 may flow from the exhaust section 106 through, e.g., an exhaust nozzle 135 to generate thrust for the propulsion system 102.

As will be appreciated, in various embodiments of the propulsion system 102 defining a gas turbine engine, rotation of the turbine(s) within the exhaust section 106 generated by the combustion products 138 is transferred through one or more shafts or spools to drive the compressor(s) within the inlet section 104. In various embodiments, the inlet section 104 may further define a fan section, such as for a turbofan engine configuration, such as to propel air across a bypass flowpath outside of the RDC system 100 and exhaust section 106.

It will be appreciated that the propulsion system 102 depicted schematically in FIG. 1 is provided by way of example only. In certain exemplary embodiments, the propulsion system 102 may include any suitable number of compressors within the inlet section 104, any suitable number of turbines within the exhaust section 106, and further may include any number of shafts or spools appropriate for mechanically linking the compressor(s), turbine(s), and/or fans. Similarly, in other exemplary embodiments, the propulsion system 102 may include any suitable fan section, with a fan thereof being driven by the exhaust section 106 in any suitable manner. For example, in certain embodiments, the fan may be directly linked to a turbine within the exhaust section 106, or alternatively, may be driven by a turbine within the exhaust section 106 across a reduction gearbox. Additionally, the fan may be a variable pitch fan, a fixed pitch fan, a ducted fan (i.e., the propulsion system 102 may include an outer nacelle surrounding the fan section), an un-ducted fan, or may have any other suitable configuration.

Moreover, it should also be appreciated that the RDC system 100 may further be incorporated into any other suitable aeronautical propulsion system, such as a turboshaft engine, a turboprop engine, a turbojet engine, a ramjet engine, a scramjet engine, etc. Further, in certain embodiments, the RDC system 100 may be incorporated into a non-aeronautical propulsion system, such as a land-based or marine-based power generation system. Further still, in certain embodiments, the RDC system 100 may be incorporated into any other suitable propulsion system, such as a rocket or missile engine. With one or more of the latter embodiments, the propulsion system may not include a compressor in the inlet section 104 or a turbine in the exhaust section 106.

Referring now to FIGS. 1-2, an exemplary embodiment of an RDC system 100 of the propulsion system of FIG. 1 is generally provided. The RDC system 100 generally includes a generally cylindrical walled enclosure 119 defining, at least in part, a combustion chamber 122, a combustion inlet 124, and a combustion outlet 126. The combustion chamber 122 defines an annular combustion chamber length 123 from approximately the combustion inlet 124 to the combustion outlet 126. The combustion chamber 122 further defines an annular gap or annular combustion chamber width 121 extended from an inner diameter wall to an outer diameter wall. The combustion chamber length 123 and the combustion chamber width 121 together define a combustion chamber volume. The combustion chamber 122 defined by the walled enclosure 119 generally defines a fixed or constant volume. In the embodiments generally provided herein, the combustion chamber length 123 and width 121 are each variables for determining the volume of the combustion chamber 122. For example, in various embodiments, the length 123 and width 121 of the combustion chamber 122 is generally sized for a minimum or lowest steady state operating condition of the propulsion system, such as a lowest pressure and temperature of oxidizer in the combustion chamber 122. The lowest steady state operating condition of the propulsion system generally results in a configuration of the RDC system 100 or, more specifically, the combustion chamber 122, at a maximum volume directly related to a detonation cell size of a fuel-oxidizer mixture in the combustion chamber 122. Still more specifically, the lowest steady state operating condition results in a configuration of the combustion chamber 122 at a maximum combustion chamber length 123 and width 121 related to a detonation cell size of fuel-oxidizer mixture in the combustion chamber 122.

In another embodiment, such as generally provided in FIG. 7, the walled enclosure 119 defines a generally annular ring structure including an outer wall 118 and an inner wall 120 spaced from one another along the radial direction R and generally concentric to the longitudinal centerline 116. The outer wall 118 and the inner wall 120 together define in part a combustion chamber 122, a combustion chamber inlet 124, and a combustion chamber outlet 126.

Referring back to FIG. 2, the RDC system 100 further includes a nozzle assembly 128 located at the combustion inlet 124. The nozzle assembly 128 provides a flow mixture of oxidizer and fuel to the combustion chamber 122, wherein such mixture is combusted/ detonated to generate the combustion products therein, and more specifically a detonation wave 130 as will be explained in greater detail below. The combustion products exit through the combustion chamber outlet 126.

The nozzle assembly 128 is defined at the upstream end of the walled enclosure 119 at the combustion chamber inlet 124. The nozzle assembly 128 generally defines a nozzle inlet 144, a nozzle outlet 146 adjacent to the combustion inlet 124 and combustion chamber 122, and a throat 152 between the nozzle inlet 144 and nozzle outlet 146. A nozzle flowpath 148 is defined from the nozzle inlet 144 through the throat 152 and the nozzle outlet 146. The nozzle flowpath 148 defines in part a primary flowpath 200 through which an oxidizer flows from an upstream end of the propulsion system through to the combustion chamber 122 and to a downstream end of the propulsion system. The nozzle assembly 128 generally defines a converging-diverging nozzle, i.e. the nozzle assembly 128 defines a decreasing cross sectional area from approximately the nozzle inlet 144 to approximately the throat 152, and further defines an increasing cross sectional area from approximately the throat 152 to approximately the nozzle outlet 146.

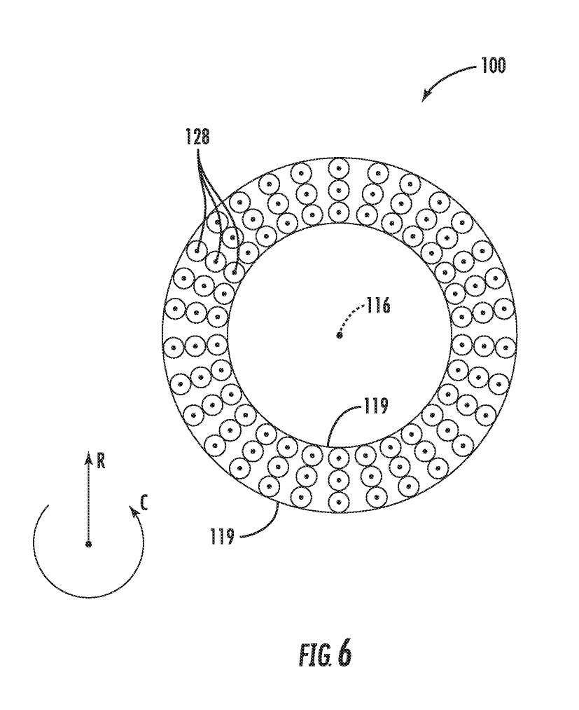

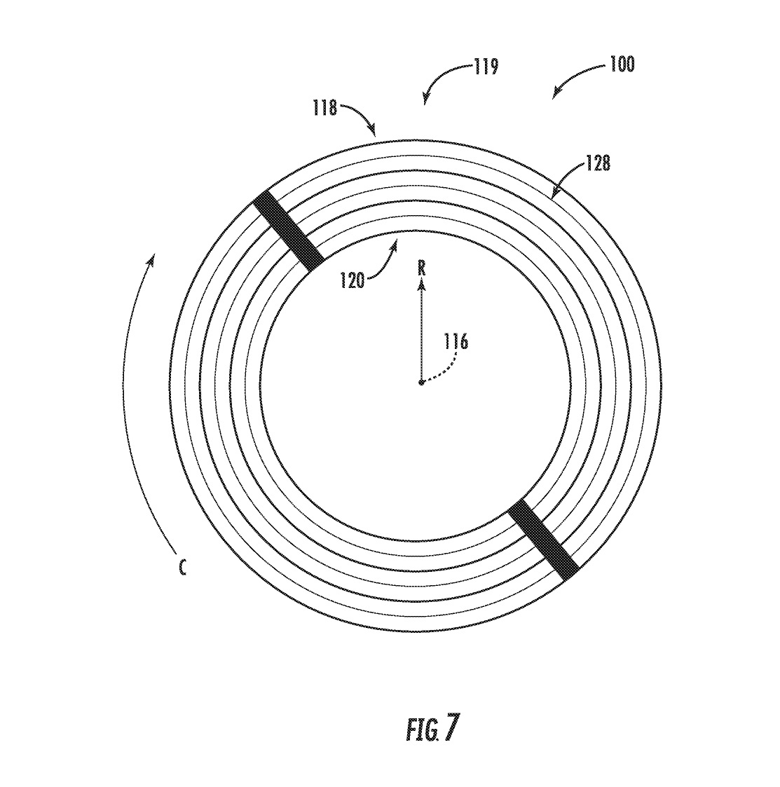

The RDC system 100 may generally define an array of fuel-oxidizer nozzle assemblies 128 in adjacent circumferential arrangement around the longitudinal centerline 116. For example, as generally provided in forward cross sectional view in FIG. 6, an array of individual nozzle assemblies 128 is disposed in adjacent along the radial direction R from the longitudinal centerline 116 and in adjacent arrangement along the circumferential direction C around the longitudinal centerline 116 (i.e, an m×n array of individual converging-diverging nozzle assemblies 128).

Between the nozzle inlet 144 and the nozzle outlet 146, a fuel injection port 162 is defined in fluid communication with nozzle flowpath 148 or, more generally, the primary flowpath 200, through which the oxidizer flows. The fuel injection port 162 introduces a liquid or gaseous fuel 163, or mixtures thereof, to the flow of oxidizer through the nozzle flowpath 148 and, generally, the primary flowpath 200. In various embodiments, the fuel injection port 162 is disposed at approximately the throat 152 of the nozzle assembly 128. In an embodiment of the RDC system 100 defining a generally annular walled enclosure 119 (e.g., defined by the outer wall 118 and the inner wall 120 as generally provided in FIG. 7) and defining a generally annular combustion chamber 122, a plurality of fuel injection ports 162 are defined in adjacent circumferential arrangement around the longitudinal centerline 116.

The primary flowpath 200 extends generally through the propulsion system from the inlet section 104 through the RDC system 100 and the exhaust section 206. In various embodiments, such as in gas turbine engines, the primary flowpath 200 extends through the compressor section through which the oxidizer is compressed before entering the RDC system 100. Furthermore, in such an embodiment, the primary flowpath 200 extends through the turbine section through which combustion products expand and drive one or more turbines that drive one or more compressors, a fan section, or a power generation apparatus.

More specifically for the RDC system 100 generally provided, the primary flowpath 200 generally extends through the length of the nozzle flowpath 148 and the combustion chamber 122. The RDC system 100 further defines a secondary flowpath 250 extended generally around the primary flowpath 200. The secondary flowpath 250 diverges from the primary flowpath 200 generally upstream of the nozzle assembly 128 and the combustion chamber 122. The secondary flowpath 250 may converge with the primary flowpath 200 at the combustion chamber 122, bypassing the nozzle assembly 128, or downstream of the combustion outlet 126, such as at the exhaust section 106. For example, the secondary flowpath 250 may converge into the primary flowpath 200 at the combustion outlet 126, at the exhaust section 106, at the exhaust nozzle 135, or into one or more other secondary flowpaths (e.g., cooling flowpath, active clearance control, etc.) downstream of the RDC system 100, and may further converge into the primary flowpath 200 thereafter. In various embodiments, such as gas turbine engines, in which the exhaust section 106 defines a turbine section, the secondary flowpath 250 may converge into the primary flowpath 200 at or downstream of a first turbine vane or nozzle.

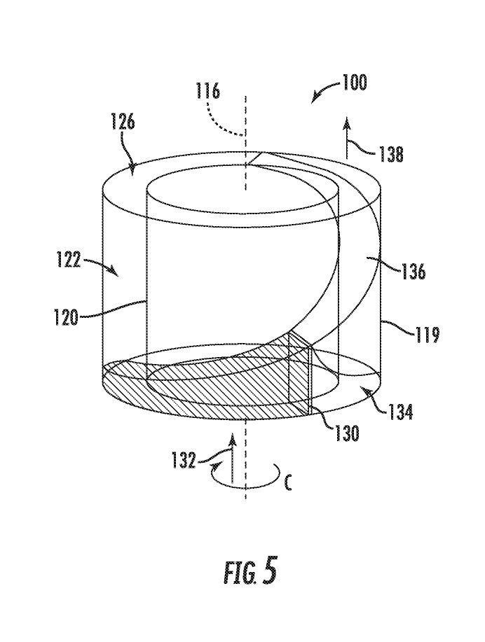

In various embodiments, the secondary flowpath 250 is defined within the RDC system 100 and generally around primary flowpath 200 within the RDC system 100 (e.g., outward of the walled enclosure 119 defining the combustion chamber 122 and primary flowpath 200), such as generally provided in FIGS. 1-3. However, in other embodiments, such as generally provided in FIG. 4, the secondary flowpath 250 may generally include a walled conduit or manifold extended outward of the RDC system 100. The secondary flowpath 250 may further extend longitudinally from upstream of the nozzle assembly 128 toward downstream. In various embodiments, the secondary flowpath 250 is annular and generally extended around the walled enclosure 119. In other embodiments, the secondary flowpath 250 may define a plurality of discrete manifolds extended from a plurality of circumferential locations. For example, the secondary flowpath 250 may define two or more walled conduits or manifolds extended from upstream of the nozzle assembly 128 to downstream of the nozzle assembly 128.

In other embodiments, the secondary flowpath 250 converges into the primary flowpath 200 upstream of the combustion outlet 126 and downstream of a detonation of the mixture of the first portion 205 of oxidizer and the fuel 163. For example, the propulsion system 102 may define a moderate to high delta pressure configuration in which the second portion 255 of oxidizer defines a high enough pressure to re-enter the primary flowpath 200 at the combustion chamber 122, overcoming the average pressure gain of a rotating detonation wave 130 (see FIG. 5).

In still various embodiments, a quantity of the second portion 255 of oxidizer may be adjusted or modulated that may increase or decrease the quantity of the second portion 255 of oxidizer extracted from the overall flow of oxidizer 195. As such, adjusting or modulating the second portion 255 of oxidizer adjusts or modulates a quantity of the first portion 205 of oxidizer going to the nozzle assembly 128 to be mixed with fuel 163 and, as such, maintain an approximately constant detonation cell size across a plurality of operating conditions of the propulsion system 102. For example, as the detonation cell size is a function of pressure, temperature, a stoichiometry of the fuel-oxidizer mixture, or more specifically, the mixture of fuel 163 and the first portion 205 of oxidizer from the overall flow of oxidizer 195, adjusting or modulating an amount of the second portion 255 of oxidizer from the overall flow of oxidizer 195 changes the amount of the first portion 205 of oxidizer mixed with the fuel 163. As such, adjusting the second portion 255 of oxidizer enables maintaining an approximately constant detonation cell size across a plurality of operating conditions.

The secondary flowpath 250 may generally provide thermal attenuation (e.g., heat transfer, or more specifically, cooling) to the RDC system 100. For example, a first portion 205 of oxidizer may flow through the primary flowpath 200 and mix with the fuel 163 for detonation in the combustion chamber 122. A second portion 255 of oxidizer may flow through the secondary flowpath 250. The second portion 255 of oxidizer may generally provide thermal attenuation, such as heat transfer generally, or, more specifically, cooling to the walled enclosure 119 of the RDC system 100.

An actuation structure 220 is disposed upstream or forward of the nozzle assembly 128 that adjusts the ratio or portion of the first portion 205 of oxidizer versus the second portion 255 of oxidizer. The actuation structure 220 generally defines an articulating vane, valve, wall, or door system that adjusts a flowpath area to adjust the quantity of the overall flow of oxidizer 195 entering the primary flowpath 200 through the nozzle assembly 128 and combustion chamber 122 as the first portion 205 versus the quantity entering the secondary flowpath 250 (i.e., bypassing mixing and detonation with the fuel 163) as the second portion 255 of oxidizer.

In the embodiments generally provided, the actuation structure 220 is disposed generally where the secondary flowpath 250 diverges from the primary flowpath 200. In various embodiments, the actuation structure 220 is defined generally upstream of the nozzle assembly 128 within the RDC system 100. In still various embodiments, the actuation structure 220 is defined generally in the inlet section 104. For example, the actuation structure 220 may define a bleed manifold assembly within the inlet section, such as within the compressor section, that may re-direct a portion of the overall flow of oxidizer 195, shown schematically as the second portion 255 of oxidizer, downstream of the nozzle assembly 128 of the RDC system 100, such as to the combustion chamber 122. In various embodiments, the secondary flowpath 250 is in fluid communication with the combustion chamber 122, such as downstream of an initial detonation of the fuel-oxidizer mixture within the combustion chamber 122. In another embodiment, the secondary flowpath 250 is in fluid communication with the combustion outlet 126 of the combustion chamber 122. In other embodiments, the secondary flowpath 250 is in fluid communication with the exhaust section 106 downstream of the combustion chamber 122.

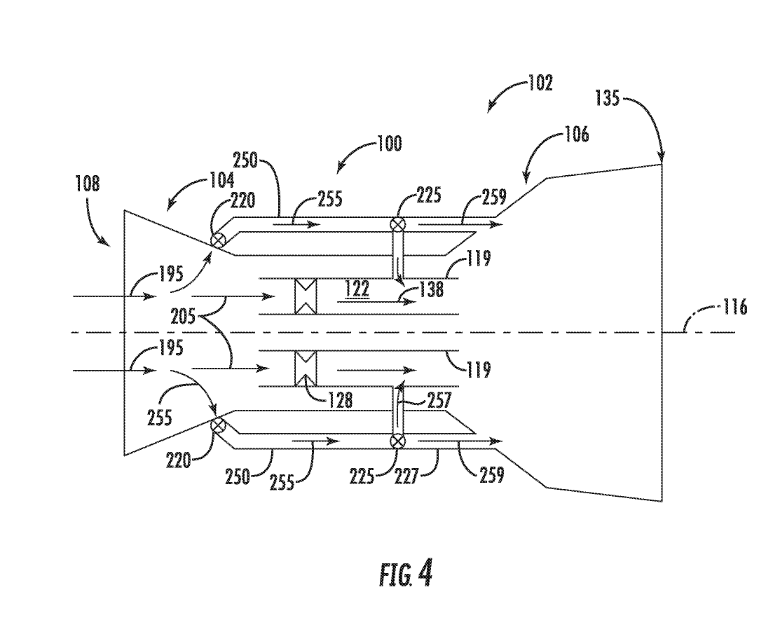

Referring now to FIG. 3, the RDC system 100 and propulsion system 102 may be configured substantially similarly as described in regard to FIGS. 1-2. However, in the exemplary embodiment generally provided in FIG. 3, the RDC system 100 further includes a second actuation structure 225 disposed within the secondary flowpath 250. The second actuation structure 225 may be configured as articulating valves, vanes, walls, or doors that may partially or completely direct flow in the secondary flowpath 250 to or from the combustion chamber 122. In one embodiment, the second actuation structure 225 defines the secondary flowpath to the combustion chamber 122 and in fluid communication therewith, and further defines a tertiary flowpath 227 extended to the exhaust section 106 and in fluid communication therewith. The second actuation structure 225 may therefore direct the second portion 255 of oxidizer entirely to the combustion chamber 122, entirely to the exhaust section 106, or further divide the second portion 255 of oxidizer into a third portion 257 directed to the combustion chamber 122 and a fourth portion 259 directed to the exhaust section 106. In various embodiments, the second actuation structure 225 is configured to adjust or modulate a ratio of the third portion 257 and fourth portion 259 of oxidizer from the second portion 255 of oxidizer.

Referring now to FIG. 4, another exemplary embodiment of the RDC system 100 and the propulsion system 102 are generally provided. The exemplary embodiment provided in FIG. 4 may be configured substantially similarly to the embodiments of the propulsion system 102 and RDC system 100 generally provided in FIGS. 1-3. However, in FIG. 4, the secondary flowpath 250 extends from the inlet section 104 to the combustion chamber 122. The actuation structure 220 is defined at the inlet section 104 generally proximate to a divergence of the secondary flowpath 250 from the primary flowpath 200. The second actuation structure 225 is defined within the secondary flowpath 250 and defines the tertiary flowpath from the second actuation structure 225 to the exhaust section 106. As generally provided in FIG. 4, the secondary flowpath 250 may generally define an annular walled conduit or manifold extended around the RDC system 100. In other embodiments, such as shown in FIG. 4, the secondary flowpath 250 may include a plurality of manifolds in circumferential arrangement around the longitudinal centerline 116 and around the propulsion system 102 or, more specifically, around the RDC system 100 and extended from the inlet section 104 to the exhaust section 106. In one embodiment, the propulsion system 102 defines a gas turbine engine, in which the secondary flowpath 250 extends from a compressor of the inlet section 104 to the combustion chamber 122, the exhaust section 106 (e.g., defining a turbine section), or both.

Referring briefly to FIG. 5, providing a perspective view of the combustion chamber 122 (without the nozzle assembly 128), it will be appreciated that the RDC system 100 generates the detonation wave 130 during operation. The detonation wave 130 travels in the circumferential direction C of the RDC system 100 consuming an incoming fuel/oxidizer mixture 132 and providing a high pressure region 134 within an expansion region 136 of the combustion. A burned fuel/oxidizer mixture 138 (i.e., combustion products) exits the combustion chamber 122 and is exhausted.

More particularly, it will be appreciated that the RDC system 100 is of a detonation-type combustor, deriving energy from the continuous wave 130 of detonation. For a detonation combustor, such as the RDC system 100 disclosed herein, the combustion of the fuel/oxidizer mixture 132 (i.e., the mixture of the fuel 163 and the first portion 205 of oxidizer through the primary flowpath 200) as generally provided in FIGS. 1-4) is effectively a detonation as compared to a burning, as is typical in the traditional deflagration-type combustors. Accordingly, a main difference between deflagration and detonation is linked to the mechanism of flame propagation. In deflagration, the flame propagation is a function of the heat transfer from a reactive zone to the fresh mixture, generally through conduction. By contrast, with a detonation combustor, the detonation is a shock induced flame, which results in the coupling of a reaction zone and a shockwave. The shockwave compresses and heats the fresh mixture 132, increasing such mixture 132 above a self-ignition point. On the other side, energy released by the combustion contributes to the propagation of the detonation shockwave 130. Further, with continuous detonation, the detonation wave 130 propagates around the combustion chamber 122 in a continuous manner, operating at a relatively high frequency. Additionally, the detonation wave 130 may be such that an average pressure inside the combustion chamber 122 is higher than an average pressure within typical combustion systems (i.e., deflagration combustion systems). Accordingly, the region 134 behind the detonation wave 130 has very high pressures.

Referring still to FIG. 5, in various embodiments, the second portion of oxidizer 255 may be introduced from the secondary flowpath 250 into the combustion chamber 122 (e.g., in which the propulsion system 102 defines a lower pressure at the combustion chamber 122 than the secondary flowpath 250). The amount of the second portion 255 of oxidizer entering the combustion chamber 122 is adjusted or modulated by the actuation structure 220, the second actuation structure 225, or both based at least on maintaining a near-constant cell size of the detonation wave 130 propagating through the combustion chamber 122. In one embodiment, the RDC system 100 and the propulsion system 102 are each configured at the first operating condition of the propulsion system 102 defining a lowest steady state pressure and temperature condition at the RDC system 100 to inject a quantity of fuel 163 through the nozzle assembly 128 to produce a detonation cell size. At a second operating condition defining a highest steady state pressure and temperature condition, the quantity of the second portion 255 from the overall flow of oxidizer 195 is removed from the primary flowpath 250 upstream of the nozzle assembly 128 (as shown in FIGS. 1-4). In one embodiment, the second portion 255 is re-introduced downstream of the nozzle assembly 128 (e.g., the exhaust section 106). The actuating structure 220, the second actuating structure, 225, or both are configured to induce an approximately equal or constant detonation cell size at the plurality of steady state and transient conditions between the lowest steady state and the highest steady state operating conditions of the propulsion system 102.

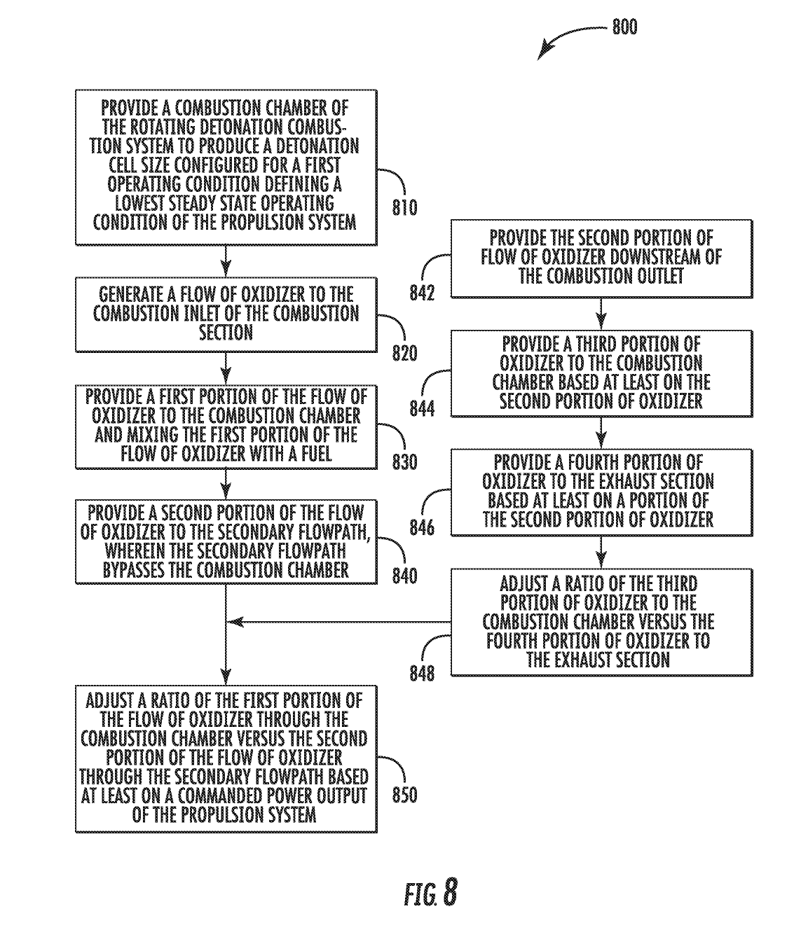

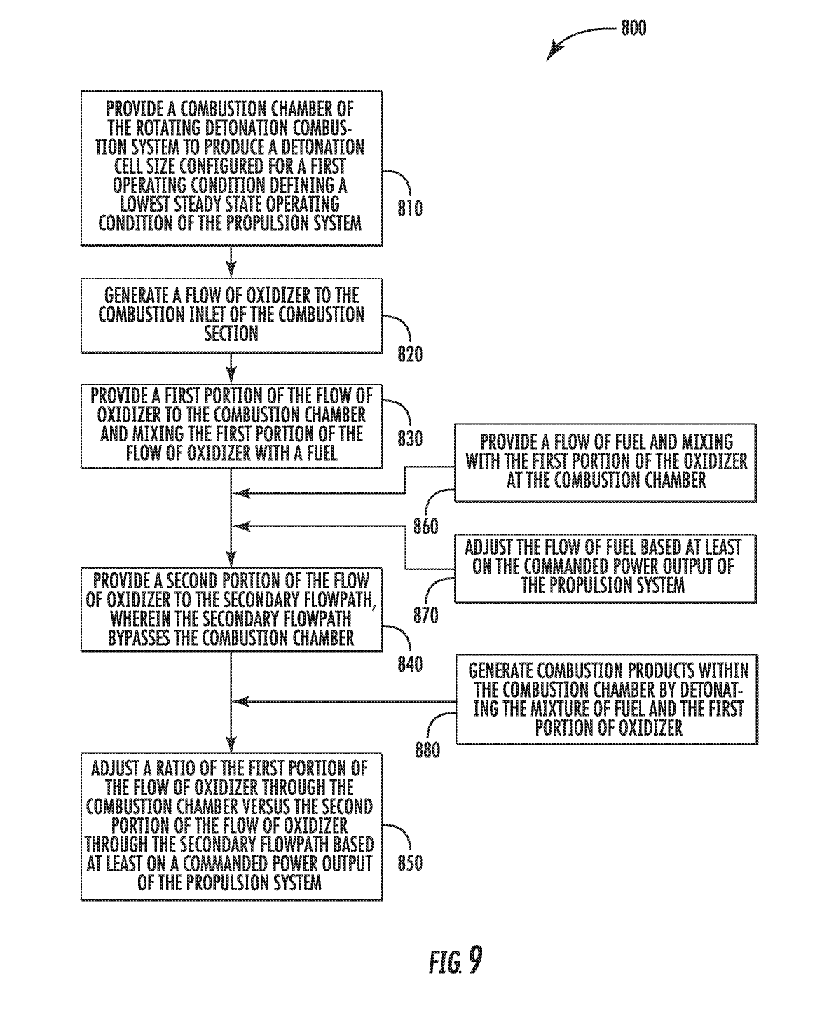

Referring now to FIGS. 8-9, a method of operating a propulsion system at an approximately constant detonation cell size is generally provided (herein after, “method 800”). The method 800 may generally enable operation of a propulsion system including a rotating detonation combustor (RDC) over an operational domain with significant differences in pressure and temperature conditions. The method 800 may enable such operation of the RDC over a plurality of operating conditions while generally maintaining a fixed combustion chamber volume defined by a combustion chamber length and width (e.g., the combustion chamber length 123 and width 121 generally provided in FIGS. 1-5). For example, the method 800 may enable a fixed volume combustion chamber to efficiently operate at a lowest steady state operating condition (e.g., ground idle) defining a minimum pressure and temperature at the RDC while also enabling operating at a highest steady state operating condition (e.g., take-off) defining a maximum pressure and temperature, as well as one or more steady state conditions therebetween defining one or more pressure and temperature conditions between a minimum and maximum condition.

The method 800 may be implemented with a propulsion system and RDC such as those described in regard to FIG. 1-7. FIGS. 8-9 depict steps performed in a particular order for purposes of illustration and discussion. Those of ordinary skill in the art, using the disclosures provided herein, will understand that the various steps of any of the methods disclosed herein can be modified, adapted, expanded, rearranged and/or omitted in various ways without deviating from the scope of the present disclosure. Still further, steps shown on either FIG. 8 or FIG. 9 may be rearranged, compiled together, separated, modified, adapted, and otherwise understood in conjunction with one another or separately.

The RDC may generally define a combustion inlet at an upstream end, a combustion outlet at a downstream end, a combustion chamber therebetween. A nozzle is defined at the combustion inlet upstream of the combustion chamber. A secondary flowpath is extended from upstream of the nozzle to downstream of the nozzle. The method 800 includes at 810 providing a combustion chamber of the rotating detonation combustion system to produce a detonation cell size configured for a first operating condition defining a lowest steady state operating condition of the propulsion system; at 820 generating a flow of oxidizer to the combustion inlet of the combustion section; at 830 providing a first portion of the flow of oxidizer to the combustion chamber and mixing the first portion of the flow of oxidizer with a fuel; at 840 providing a second portion of the flow of oxidizer to the secondary flowpath, wherein the secondary flowpath bypasses the combustion chamber; and at 850 adjusting a ratio of the first portion of the flow of oxidizer through the combustion chamber versus the second portion of the flow of oxidizer through the secondary flowpath based at least on a commanded power output of the propulsion system.

At 810, providing the combustion chamber of the RDC system generally includes providing a fixed or constant volume combustion chamber such as described in regard to the RDC system 100 of FIGS. 1-7. As such, the step at 810 may generally enable the RDC system to ignite and operate at a lowest steady state operating condition with desirable combustion and propulsion system stability, efficiency, and performance. Desirable stability, efficiency, and performance may include desirable combustion stability (e.g., minimal or reduced pressure oscillations), reduced emissions or generally emissions compliance, and minimal fuel burn. In various embodiments, such as in gas turbine engines, the lowest steady state operating condition may define a ground idle condition, or another idle condition generally characterized as the lowest steady state pressure and temperature through the propulsion system following ignition.

In reference to FIGS. 1-9, the step at 820 includes generating a flow of oxidizer to the combustion inlet 124. In various embodiments, such as gas turbine engines, generating a flow of oxidizer includes operating a fan section and/or compressor section. In other embodiments, generating a flow of oxidizer may include ingesting a flow of oxidizer through an inlet section of the propulsion system, such as in a ramjet or scramjet apparatus.

At 830, providing a first portion of the flow of oxidizer and mixing with a fuel may include providing the first portion 205 of oxidizer and the fuel 163 through the nozzle assembly 128 such as shown and described in regard to the RDC system 100 of FIGS. 1-7. In various embodiments, providing the first portion of oxidizer may include inducing a bulk swirl along a circumferential direction relative to the longitudinal centerline 116. The bulk swirl may be induced upstream of the throat 152 of the nozzle assembly 128, or downstream of the throat 152 after the fuel 163 has been introduced to the oxidizer through the primary flowpath 200. In still various embodiments, providing the first portion 205 of oxidizer through the nozzle assembly 128 to the combustion chamber 122 may include providing the first portion 205 through a plurality of nozzle assemblies 128, combustion chambers 122, or both.

Referring still to the embodiments of the RDC system 100 shown and described in regard to FIGS. 1-7, in various embodiments, the method 800 at 840 includes providing the second portion 255 of oxidizer to the secondary flowpath 250. As described in regard to FIGS. 1-7, providing the second portion 255 of oxidizer may include separating a portion of oxidizer from the overall flow of oxidizer 195 generally upstream of the nozzle assembly 128. In one embodiment, providing the second portion 255 of oxidizer to the secondary flowpath 250 of the RDC system 100 includes flowing the second portion 255 of oxidizer proximate to the combustion chamber 122 to induce thermal attenuation of the combustion chamber 122, or, more specifically, the walled enclosure 119 defining the combustion chamber 122.

In various embodiments, providing the second portion 255 of oxidizer through the secondary flowpath 250 includes reintroducing the second portion 255 of oxidizer to the primary flowpath 250 downstream of a detonation of the mixture of the fuel 163 and the first portion 205 of oxidizer. In such an embodiment, the downstream re-entry of the second portion 255 of the oxidizer may include defining a generally moderate to high delta pressure propulsion system 102 in which the second portion 255 of oxidizer defines a pressure higher than the average pressure of the detonation wave 130.

In one embodiment, the method 800 further includes at 842 providing the second portion of flow of oxidizer downstream of the combustion outlet. For example, referring to FIGS. 1-9, the second portion 255 of oxidizer may flow through the secondary flowpath 250 and flow into the exhaust section 106. In various embodiments, the step at 842 includes providing the second portion 255 of oxidizer to one or more of a turbine section, an exhaust section, a secondary flowpath of the turbine section (e.g., cooling, active clearance control, etc.), and an atmospheric condition. For example, the propulsion system 102 may define a low delta pressure configuration.

Referring still to the embodiments of the propulsion system 102 and RDC system 100 generally shown and described in regard to FIGS. 1-9, adjusting a ratio of the first portion of the flow of oxidizer through the combustion chamber versus the second portion of the flow of oxidizer through the secondary flowpath is based on the overall flow of oxidizer 195 and based at least on a commanded power output of the propulsion system 102. In various embodiments, the commanded power output is a throttle level position or power level angle (PLA), or another requested or commanded power output from a user or control interface. A computer-based system, such as a controller, may provide a commanded fuel flow rate or pressure, bleed valve position, variable stator vane position of a compressor, etc. to adjust the power output of the propulsion system based on the commanded power output.

The commanded power output may generally include a range of power outputs from a start-up or ignition to a lowest steady state operating condition (e.g., ground idle), to a highest steady state operating condition (e.g., maximum takeoff, or another maximum rated power output of the propulsion system), and one or more conditions therebetween (e.g., flight idle, cruise, climb, approach, etc. for aviation gas turbine engines, or equivalents for other propulsion system apparatuses).

In still various embodiments at 850, adjusting a ratio of the first portion 205 and the second portion 255 of oxidizer is based at least on maintaining an approximately constant detonation cell size at a second operating condition of the propulsion system greater than the first operating condition defining a lowest steady state operating condition. In one embodiment, maintaining an approximately equal detonation cell size includes adjusting a stoichiometric ratio of detonated fuel 163 and first portion 205 of oxidizer mixture.

In another embodiment at 850, adjusting the ratio of the first portion 205 and the second portion 255 of the flow of oxidizer further includes adjusting one or more of a flow of the overall flow of oxidizer 195 to the RDC system 100 and a flow of fuel 163 to the nozzle assembly 128 and the combustion chamber 122. For example, adjusting the overall flow of oxidizer 195 may include increasing or decreasing a rotational speed of a compressor section, articulating one or more of a bleed valve, variable stator vane, or both, or adjusting an inlet nozzle.

In still another embodiment at 850, adjusting the ratio of the first portion 205 versus the second portion 255 of the overall flow of oxidizer 195 includes actuating the actuating structure 220 such as generally shown and described in regard to FIGS. 1-7. In various embodiments, actuating or articulating the actuating structure 220 includes adjusting one or more of a vane position, a valve position, a door or wall, in which actuating, articulating, or adjusting varies the ratio of the first portion 205 and the second portion 255 of the oxidizer from the overall flow of oxidizer 195 entering the RDC system 100. For example, adjusting the ratio may include directing or re-directing varying quantities of the oxidizer to the secondary flowpath 250 from the primary flowpath 200.

In various embodiments, the method 800 further includes at 860 providing a flow of fuel and mixing with the first portion of the oxidizer at the combustion chamber; and at 870 adjusting the flow of fuel based at least on the commanded power output of the propulsion system. For example, as previously mentioned, the commanded power output of the propulsion system may include startup or ignition, a lowest steady state operating condition, a highest steady state operating condition, one or more steady state operating conditions therebetween, and transient operating conditions therebetween.

Referring to FIGS. 1-9, providing a flow of fuel at 860 may include providing the fuel 163 through the fuel injection port 162 of the nozzle assembly 128. The fuel 163 egresses into the primary flowpath 200 and mixes with the first portion 205 of oxidizer flowing toward and into the combustion chamber 122. Adjusting the flow of fuel at 870 includes one or more of adjusting a pressure or flow rate of the fuel 163, or adjusting a metering valve, pump, etc. that provides the flow of fuel 163 to the RDC system 100. In still other embodiments, adjusting the flow of fuel 163 may include adjusting the flow to one or more circumferential locations of the fuel injection port 162 disposed circumferentially in the RDC system 100.

In yet various embodiments, the method 800 further includes at 844 providing a third portion of oxidizer to the combustion chamber based at least on the second portion of oxidizer; at 846 providing a fourth portion of oxidizer to the exhaust section based at least on a portion of the second portion of oxidizer; and at 848 adjusting a ratio of the third portion of oxidizer to the combustion chamber versus the fourth portion of oxidizer to the exhaust section.

For example, referring to FIGS. 1-5, providing the third portion 257 of oxidizer to the combustion chamber 122 may include providing at least a portion or fraction of the second portion 255 of oxidizer. In one embodiment, the second actuating structure 225 may direct 100% of the second portion 255 of oxidizer (shown schematically in the figures as the third portion 257) to the combustion chamber 122. In other embodiments, the second actuating structure 225 may direct a ratio or fraction of the second portion 255 of oxidizer to the combustion chamber 122 and the exhaust section 106. In still other embodiments, the second actuating structure 225 may completely or entirely direct the second portion 255 of oxidizer to the exhaust section 106 as schematically shown as the fourth portion 259 of oxidizer. In various embodiments, the ratio or portion of the second portion 255 directed to the combustion chamber 122 is based at least in part on maintaining an approximately constant detonation cell size at a plurality of operating conditions of the propulsion system 102 relative to the first operating condition defining a lowest steady state operating condition. In still various embodiments, maintaining an approximately constant detonation cell size includes one or more of adjusting a flow of the fuel 163 to the combustion chamber 122.

In still another embodiment, the method 800 further includes at 880 generating combustion products within the combustion chamber by detonating the mixture of fuel and the first portion of oxidizer, such as generally provided in FIGS. 1-7 regarding the combustion products 138, the combustion chamber 122, and the detonation wave 130 produced from the mixture of the fuel 138 and the first portion 205 of oxidizer.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a propulsion system comprising a rotating detonation combustion (RDC) system, wherein the RDC system defines a combustion inlet at an upstream end, a combustion outlet at a downstream end, and a combustion chamber therebetween, and a nozzle defined at the combustion inlet upstream of the combustion chamber, and a secondary flowpath extended from upstream of the nozzle to downstream of the nozzle, the method comprising:
providing the combustion chamber of the rotating detonation combustion system to produce a detonation cell size configured for a first operating condition defining a lowest steady state operating condition of the propulsion system;
generating a flow of oxidizer to the combustion inlet of the combustion section;
providing a first portion of the flow of oxidizer to the combustion chamber and mixing the first portion of the flow of oxidizer with a fuel;
providing a second portion of the flow of oxidizer to the secondary flowpath, wherein the secondary flowpath bypasses the combustion chamber; and
adjusting a ratio of the first portion of the flow of oxidizer through the combustion chamber versus the second portion of the flow of oxidizer through the secondary flowpath based at least on a commanded power output of the propulsion system.

2. The method of claim 1, wherein adjusting the ratio of the first portion versus the second portion of the flow of oxidizer includes actuating an actuating structure at the primary flowpath and the secondary flowpath upstream of the combustion chamber and at or downstream of the combustion inlet of the combustion section.

3. The method of claim 2, wherein actuating the actuating structure includes one or more of actuating a vane, valve, door, or wall varying the ratio of the flow of the first portion versus the second portion of the flow of oxidizer.

4. The method of claim 1, wherein adjusting a ratio of the first portion and second portion of oxidizer is based at least on maintaining an approximately constant detonation cell size at a stoichiometric ratio of detonated fuel and first portion of oxidizer of approximately 1.0 or less at a second operating condition greater than the first operating condition of the propulsion system.

5. The method of claim 1, the method further comprising providing the second portion of flow of oxidizer from the secondary flowpath to the primary flowpath.

6. The method of claim 5, wherein providing the second portion of flow of oxidizer to the primary flowpath includes providing the second portion to combustion products downstream of a detonation wave of the mixture of the first portion of oxidizer and fuel.

7. The method of claim 5, wherein providing the second portion of flow of oxidizer includes providing the second portion of oxidizer to one or more of a turbine section, an exhaust section, and atmospheric condition.

8. The method of claim 1, wherein providing the second portion of the flow of oxidizer to the secondary flowpath includes flowing the second portion of oxidizer proximate to the combustion chamber to induce thermal attenuation of the combustion chamber.

9. The method of claim 1, wherein adjusting the ratio of the first portion and second portion of the flow of oxidizer based at least on a commanded power output further includes adjusting one or more of a flow of oxidizer to the rotating detonation combustion system and a flow of fuel to the combustion chamber.

10. The method of claim 1, further comprising:
providing a flow of fuel and mixing with the first portion of the oxidizer at the combustion chamber; and
adjusting the flow of fuel based at least on the commanded power output of the propulsion system.

11. The method of claim 1, further comprising:
providing a third portion of oxidizer to the combustion chamber based at least on the second portion of oxidizer;
providing a fourth portion of oxidizer to the exhaust section based at least on a portion of the second portion of oxidizer; and
adjusting a ratio of the third portion of oxidizer to the combustion chamber versus the fourth portion of oxidizer to the exhaust section.

12. The method of claim 11, wherein adjusting the ratio of the third portion of oxidizer versus the fourth portion of oxidizer is based at least on the commanded power output of the propulsion system.

13. The method of claim 11, wherein adjusting a ratio of the third portion of oxidizer to the combustion chamber is further based at least on maintaining an approximately equal detonation cell size from the first operating condition to a second operating condition greater than the first operating condition of the propulsion system.

14. The method of claim 1, wherein providing the combustion chamber of the rotating detonation combustion system includes providing a fixed volume combustion chamber defined by a combustion chamber length and a combustion chamber width.

15. The method of claim 1, further comprising:
generating combustion products within the combustion chamber by detonating the mixture of fuel and the first portion of oxidizer.

16. A propulsion system, the propulsion system comprising:
an inlet section at the upstream end into which an oxidizer flows;
an exhaust section at the downstream end; and
a rotating detonation combustion (RDC) system disposed between the inlet section and the exhaust section through which a primary flowpath of the oxidizer is defined through the inlet section, the exhaust section, and the RDC system, wherein the RDC system comprises a generally cylindrical walled enclosure defining a combustion chamber, a combustion inlet, and a combustion outlet, and further comprising a nozzle assembly at the combustion inlet, wherein the nozzle assembly defines a nozzle inlet proximate to the inlet section, a nozzle outlet proximate to the combustion chamber, and a throat and fuel injection port each disposed therebetween, and wherein the nozzle assembly defines a converging-diverging nozzle; and
an actuation structure disposed upstream of the nozzle assembly of the RDC system, wherein a secondary flowpath is defined from the actuation structure to the combustion chamber or downstream thereof and bypassing the nozzle assembly, and wherein the actuation structure is configured to adjust a ratio from an overall flow of oxidizer of a first portion of oxidizer through the primary flowpath through the nozzle assembly and the combustion chamber and a second portion of oxidizer to through the secondary flowpath bypassing the nozzle assembly.

17. The propulsion system of claim 14, wherein the actuation structure defines a plurality of articulating vanes, valves, walls, doors, or combinations thereof

18. The propulsion system of claim 14, wherein the actuation structure is disposed in the inlet section of the propulsion system.

19. The propulsion system of claim 14, further comprising:
a second actuation structure disposed within the secondary flowpath, wherein the secondary flowpath extends to and in fluid communication with the combustion chamber, and wherein a tertiary flowpath is defined from the second actuation structure to the exhaust section.

20. The propulsion system of claim 19, wherein the second actuation structure is configured to adjust a ratio from the second portion of oxidizer of a third portion of oxidizer to the combustion chamber and a fourth portion of oxidizer to the exhaust section.
